(19) United States
(12) Patent Application Publication
(10) Pub. No.: US 2016/0142269 A1
(43) Pub. Date: May 19, 2016

(54) Inline Packet Tracing in Data Center Fabric Networks

(71) Applicant: Cisco Technology, Inc., San Jose, CA (US)

(72) Inventors: Satyadeva Prasad Konduru, San Jose, CA (US); Bharat Kumar Bandaru, San Jose, CA (US)

(21) Appl. No.: 14/621,582

(22) Filed: Feb. 13, 2015

Related U.S. Application Data
(60) Provisional application No. 62/081,061, filed on Nov. 18, 2014.

(51) Int. Cl. H04L 12/26; H04L 12/751

(52) U.S. Cl. CPC H04L 43/026; H04L 43/028; H04L 43/06; H04L 45/02; H04L 43/04; H04L 43/0829

(57) ABSTRACT

Presented herein are embodiments for tracing paths of packet flows in a data center fabric network. Filters are configured on nodes (e.g., switches) in the data center fabric network for a particular packet flow. Numerous such filters can be configured on each of the switches, each filter for a different packet flow. When a filter detects a match, it sends a log of such occurrence to a network controller. The network controller uses log data sent from nodes as well as knowledge of the network topology (updated as changes occur in the network) to determine the path for a particular packet flow in the data center fabric network. This technique works inline on the actual packet flow and does not need additional debug packets to be injected. This technique can also quickly point out the problem node in case of traffic drop.

### CROSS-REFERENCE TO RELATED APPLICATION

This application claims priority to U.S. Provisional Application No. 62/081,061, filed Nov. 18, 2014, the entirety of which is incorporated herein by reference.

### TECHNICAL FIELD

The present disclosure relates to data center fabric networks.

### BACKGROUND

Data center fabric solutions, such as Leaf-Spine architectures, involve complex routing and load balancing algorithms to send a packet from one node to another in the data center fabric. In fabrics using dynamic load balancing schemes, the same packet flow can take a different path at different times based on the bandwidth it consumes. Traditional packet trace utilities inject a packet to the desired destination, but it may not trace the actual packet flow because the packet hashes may not match.

### BRIEF DESCRIPTION OF THE DRAWINGS

FIG. 1 is a block diagram showing a data center fabric network in which packet tracing is performed according to example embodiments presented herein.

FIG. 2 is a more detailed block diagram showing components of a network controller and individual data center nodes (e.g., switches) configured to perform packet tracing according to example embodiments presented herein.

FIG. 3 is a diagram similar to FIG. 1, but showing how dynamic load balancing can change a packet path, and how the packet tracing techniques can adapt to such dynamic load balancing (and a packet drop in the new path) according to example embodiments presented herein.

FIG. 4 is a flow chart depicting a process for packet tracking according to example embodiments presented herein.

### DESCRIPTION OF EXAMPLE EMBODIMENTS

### Overview

Presented herein are embodiments for tracing paths of packet flows in a data center fabric network. Filters are configured on nodes (e.g., switches) in the data center fabric network for a particular packet flow. Numerous such filters can be configured on each of the nodes, each filter for a different packet flow. When a filter detects a match, it outputs a log of such occurrence to a network controller. The network controller uses log data sent from the nodes as well as knowledge of the network topology (updated as changes occur in the network) to determine the path for a particular packet flow in the data center fabric network.

Thus, from the perspective of the network controller, a method is provided in which filter configuration information is generated to track a particular packet flow, the filter configuration information including one or more parameters of the particular packet flow. The filter configuration information is sent to the plurality of nodes in order to configure a filter for the particular packet flow at each of the plurality of nodes. The network controller receives from one or more of the plurality of nodes where a filter match occurs output indicating that a packet matching the filter configuration information for the filter for the particular packet flow passed through the associated node. The network controller analyzes the output received from one or more of the plurality of nodes where a filter match occurs to determine a path through the network for the particular packet flow.

### DETAILED DESCRIPTION

There are no techniques available that can accurately trace a specific packet flow in current advanced data center fabric networks. In accordance with embodiments presented herein, packet path tracing can be done “inline” on the actual packet flow itself in data center fabric networks. This avoids the need to inject a new packet. Performing packet path tracing inline can also quickly pinpoint where and why in the network, a packet flow is getting dropped if it is because of a forwarding drop.

The techniques involve using filters in the network switches (data center nodes) and analyzing the filter output with the network topology information to generate (“stitch”) the path of a packet in the network.

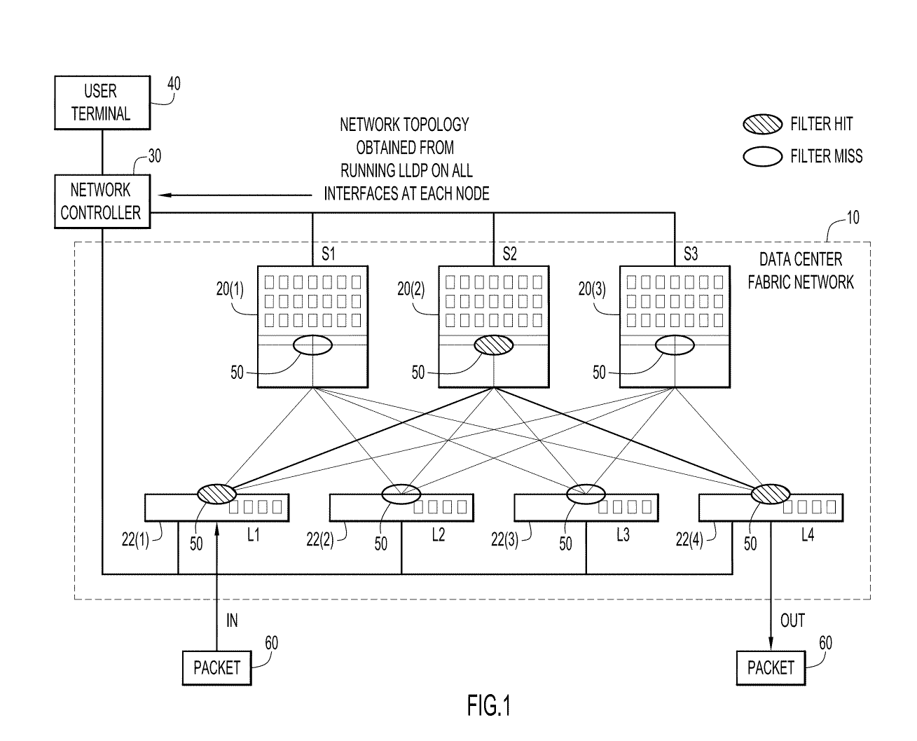

Reference is first made to FIG. 1. FIG. 1 shows a data center fabric network 10 that includes a plurality of data center switches (more generally referred to as data center nodes) arranged in a Spine-Leaf architecture. For example, the data center fabric includes spine nodes S1, S2 and S3 and leaf nodes L1, L2, L3 and L4. Connections between the spine and leaf nodes are such that each leaf node is connected to one or more spine nodes. The spine nodes S1, S2 and S3 are shown at reference numerals 20(1), 20(2) and 20(3), and the leaf nodes are shown at reference numerals 22(1), 22(2), 22(3) and 22(4). This a simplified diagram and it should be understood that there are typically numerous more nodes in an actual network deployment.

A network controller 30 is in communication with each of the spine nodes S1, S2 and S3 and with each of the leaf nodes L1, L2, L3 and L4. A user (e.g., a network administrator) can log onto the network controller (locally or remotely via the Internet) from a user terminal 40. The user terminal 40 may be a desktop computer, server, laptop computer, or any computing/user device with network connectivity and a user interface.

The topology of the fabric network can change dynamically as some nodes may go down. With the Link Layer Discovery Protocol (LLDP) always running between the nodes, the current topology is always available at the network controller 30. In addition to the topology change, the nodes may also perform dynamic load balancing techniques to avoid congested paths in the network. Both of these factors can change the path taken by a packet flow.

FIG. 1 shows an example in which a filter 50 for a particular packet/traffic flow is configured on all of the nodes in the data center fabric 10. That is, parameters for the filter 50 matching the desired packet flow to be traced are configured on all the nodes. To trace a packet or packet flow, the filter 50 composed of data for one or more fields of the packet is configured on all the nodes in the data center network fabric. A packet 60 enters the data center network fabric 10 at leaf node L1 as shown in FIG. 1. Whenever a packet matches the parameters of a filter, the node logs the information and/or raises an event to the processor in the node. In the example of FIG. 1, the nodes marked with filters 50 having the cross-hatched pattern and the nodes where the packet flow hit (“matched”) the filter 50, that is, at nodes L1, S2 and L4.

When a filter hit (match) occurs, output is generated including, among other things, information identifying the incoming interface (port) on the node at which the packet is received on the node where the filter hit occurs. This information is sent from the nodes where the filter hits occur to the network controller 30.

The network controller 30 correlates the nodes at which a filter hit is reported with the network topology of the fabric. As described above, the network topology of the fabric can be obtained from simple link level protocols like LLDP, which publishes all the neighbors of a given switch. By looking up the incoming interface information in an LLDP or other similar database, the network controller 30 can determine the neighbor switch that sent the packet. By deducing this information at every node where the packet is seen, the entire packet path can be determined. Thus, the network controller 30 analyzes the filter hit information, including the incoming interface of the packet on the nodes that hit the filter, against the network topology (obtained for example using LLDP) information to build the entire path of the packet flow in the data center fabric network.

The system depicted in FIG. 1 may be configured to operate in accordance with an Application Centric Infrastructure (ACI). ACI in the data center is an architecture with centralized automation and policy-driven application profiles. ACI delivers software flexibility with the scalability of hardware performance. ACI includes simplified automation by an application-driven policy model, centralized visibility with real-time, application health monitoring, and scalable performance and multi-tenancy in hardware.

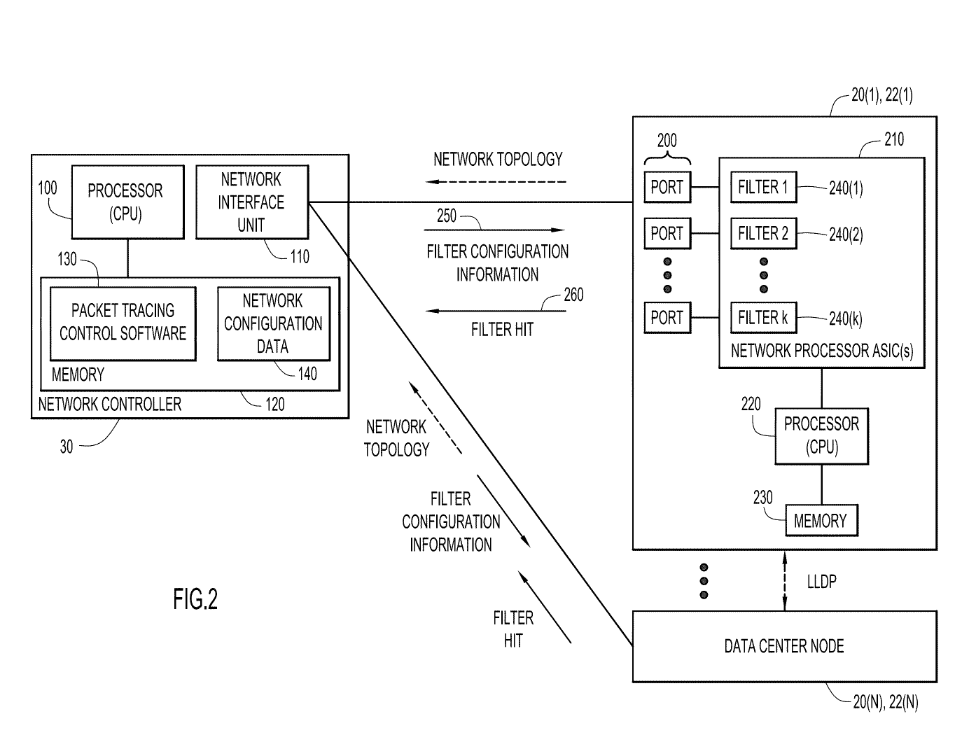

Reference is now made to FIG. 2. FIG. 2 shows in more detail the network controller 30 and the relevant components of data center nodes that support the embodiments presented herein. The network controller 30 includes a processor (e.g., a central processing unit) 100, a network interface unit (e.g., one or more network interface cards) 110, and memory 120. The memory 120 stores instructions for packet tracing control software 130 and also network configuration data 140 indicating up-to-date network topology of the data center fabric network obtained by running LLDP on all the interfaces at each node.

The data center nodes, referred to by reference numerals 20(1), 22(1)-20(N), 22(N), include a plurality of ports 200, one or more network processor Application Specific Integrated Circuit (ASICs) 210, a processor 220 and memory 230. Within the network processor ASICs 210 there are one or more configurable filters 240(1)-240(N), shown as Filter 1-Filter N. These are the filters that the network controller 30 can program/configure on each data center node to track certain packet flows. The network controller 30 sends filter configuration information 250 in order to configure that same filter on each data center node for each packet flow to be tracked. For example, Filter 1 would be configured with appropriate parameters/attributes on each data center node to track packet flow 1, Filter 2 would be configured with appropriate parameters/attributes on each data center node to track packet flow 2, and so on. The data center nodes return to the network controller filter hit information 260. As generally described above, the filter hit information 260 to be logged at the network controller includes the information identifying the incoming interface of the packet at the node where the filter match (“hit”) occurred. The network processor ASICs 210 may be further capable of capturing additional forwarding information like forward or drop packet action, next hop details etc. In one form, the filters are instantiated with Embedded Logic Analyzer Module (ELAM) technology. However, in general, the filters may be implemented using configurable digital logic in the network processor ASICs, or in software stored in the memory and executed by the processor within each data center node.

The memory 130 in the network controller 30 and the memory 230 in the data center nodes may include read only memory (ROM), random access memory (RAM), magnetic disk storage media devices, optical storage media devices, flash memory devices, electrical, optical, or other physical/tangible memory storage devices. Thus, in general, the memory shown in FIG. 2 may include one or more tangible (non-transitory) computer readable storage media (e.g., a memory device) encoded with software comprising computer executable instructions and when the software is executed (by the controller) it is operable to perform the operations described herein.

The filter can be based on any field of a packet, e.g., any field in the L2 header, L3 header or L4 header of a packet. Examples of packet fields/attributes that may be used for a packet filter include (but are not limited to):

Source media access control (MAC) address (inner and/or outer depending whether tunneling is used)

Destination MAC address (inner and/or outer depending whether tunneling is used)

Source Internet Protocol (IP) address (inner and/or outer depending whether tunneling is used)

Destination IP address (inner and/or outer depending whether tunneling is used)

Domain name of the node (switch)

Port number

Layer 4 (e.g., Universal Datagram Protocol (UDP) or Transport Control Protocol (TCP) Source Port or Destination Port

Virtual Network Identifier (VNID) for a Virtual Extensible Local Area Network (VxLAN) packet

Virtual Local Area Network (VLAN) identifier

Values for one or more of these fields would be set. If a packet arrives at a node that has a value(s) that matches the value set for a corresponding field in the filter, then a match is declared.

The following is example output that may be generated by filters at nodes in a network. Naming conventions are used for the various nodes, but this is arbitrary.

List of Switches in the network where a particular filter is configured:

ifav43-leaf2,ifav43-leaf3,ifav43-leaf4,ifav43-leaf6,ifav43-leaf7,ifav43-leaf8,ifav43-leaf9,ifav43-
leaf5,ifav43-leaf1,ifav43-spine1
ingress-tor (top of rack): 43-leaf5
inner-dip: 240.121.255.232
log_file: /tmp/1
in_select 4 out_select 5
Starting ELAM on ifav43-leaf2
Starting ELAM on ifav43-leaf3
Starting ELAM on ifav43-leaf4
Starting ELAM on ifav43-leaf6
Starting ELAM on ifav43-leaf7
Starting ELAM on ifav43-leaf8
Starting ELAM on ifav43-leaf9
Starting ELAM on ifav43-leaf5
Starting ELAM on ifav43-leaf1
Starting ELAM on ifav43-spine1
LC 1
LC 3
Capturing ELAM on ifav43-leaf2
Capturing ELAM on ifav43-leaf3
Capturing ELAM on ifav43-leaf4
ifav43-leaf4 ASIC 0 INST 1 DIR EGRESS MATCHED

| | | | | |
|---|---|---|---|---|
| ifav43-leaf4 −> 43-spine1 | Eth1/49 | 120 | BR | Eth3/33 |

Capturing ELAM on ifav43-leaf6
ifav43-leaf6 ASIC 0 INST 1 DIR EGRESS MATCHED

| | | | | |
|---|---|---|---|---|
| ifav43-leaf6 −> 43-spine1 | Eth1/49 | 120 | BR | Eth3/11 |

Capturing ELAM on ifav43-leaf7
ifav43-leaf7 ASIC 0 INST 1 DIR EGRESS MATCHED

| | | | | |
|---|---|---|---|---|
| ifav43-leaf7 −> 43-spine1 | Eth1/59 | 120 | BR | Eth1/29 |

Capturing ELAM on ifav43-leaf8
Capturing ELAM on ifav43-leaf9
Capturing ELAM on ifav43-leaf5
ifav43-leaf5 ASIC 0 INST 0 DIR INGRESS MATCHED
Capturing ELAM on ifav43-leaf1
ifav43-leaf1 ASIC 0 INST 1 DIR EGRESS MATCHED

| | | | | |
|---|---|---|---|---|
| ifav43-leaf1 −> 43-spine1 | Eth1/49 | 120 | BR | Eth1/33 |

Capturing ELAM on ifav43-spine1
LC 1
LC 3
ifav43-spine1 ASIC 1 INST 3 DIR EGRESS MATCHED
ifav43-spine1 ASIC 0 INST 3 DIR EGRESS MATCHED
ifav43-spine1 ASIC 1 INST 1 DIR INGRESS MATCHED

| | | | | |
|---|---|---|---|---|
| ifav43-spine1 −> 43-leaf5 | Eth3/23 | 120 | BR | Eth1/49 |

ifav43-spine1 ASIC 1 INST 3 DIR EGRESS MATCHED
TOR INGRESS: [‘43-leaf5’]
SPINE INGRESS: [‘43-leaf5:Eth1/49::Eth3/23:43-spine1’]
SPINE EGRESS: [‘43-spine1’, ‘43-spine1’, ‘43-spine1’]
TOR EGRESS: [‘43-spine1:Eth3/33::Eth1/49:43-leaf4’, ‘43-spine1:Eth3/11::Eth1/49:43-leaf6’,
‘43-spine1:Eth1/29::Eth1/59:43-leaf7’, ‘43-spine1:Eth1/33::Eth1/49:43-leaf1’]
Ingress TOR: 43-leaf5

The path of the packet determined from data captured from the nodes where matches occurred:

| Input Port | Switch | Output Port |
|---|---|---|
| | 43-leaf5 | Eth1/49 |
| Eth3/23 | 43-spine1 | Eth3/33 |
| Eth1/49 | 43-leaf4 | |

Thus, the network controller 30 receives data output from the filters that had a match, and builds a database from that data. Using the network configuration information stored (and continuously updated) at the network controller 30, the network controller 30 can then build a list indicating the nodes along the path of the packet flow.

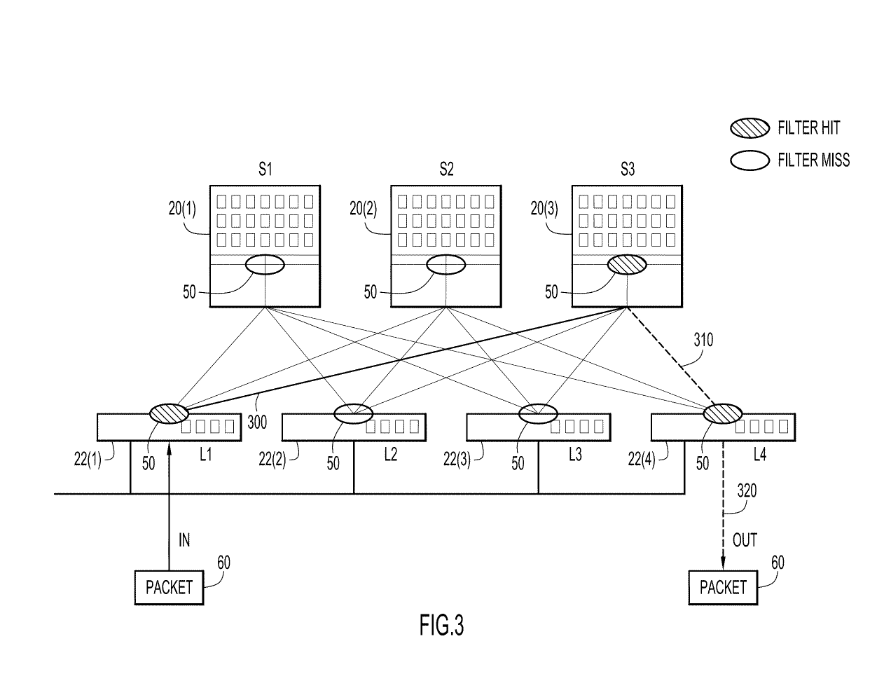

Reference is now made to FIG. 3. FIG. 3 is similar to FIG. 1, but illustrates an example of a packet path 300 changing due to dynamic load balancing in the data center network fabric. Dynamic load balancing can cause a packet flow to change its path because of various conditions, such as changes in bandwidth of the flow, congestion of the network, one or more nodes going down, etc.

Furthermore, FIG. 3 shows that in any path, e.g., the new path, the packet flow can get dropped because of various reasons. If the customer or user chooses to run the inline packet tracing tool at regular intervals, it can show the packet path changing from one set of nodes to another. Any drop in any path can be debugged quickly as the forwarding information is captured from all the nodes in the path.

FIG. 3 shows the packet path 300 changing through a new set of nodes and the flow getting dropped at node ‘S3’. The dotted lines 310 and 320 show the intended path if the flow has not been dropped. A review of the forwarding state at node S3 would pinpoint the problem to be either a configuration mistake or a software programming error.

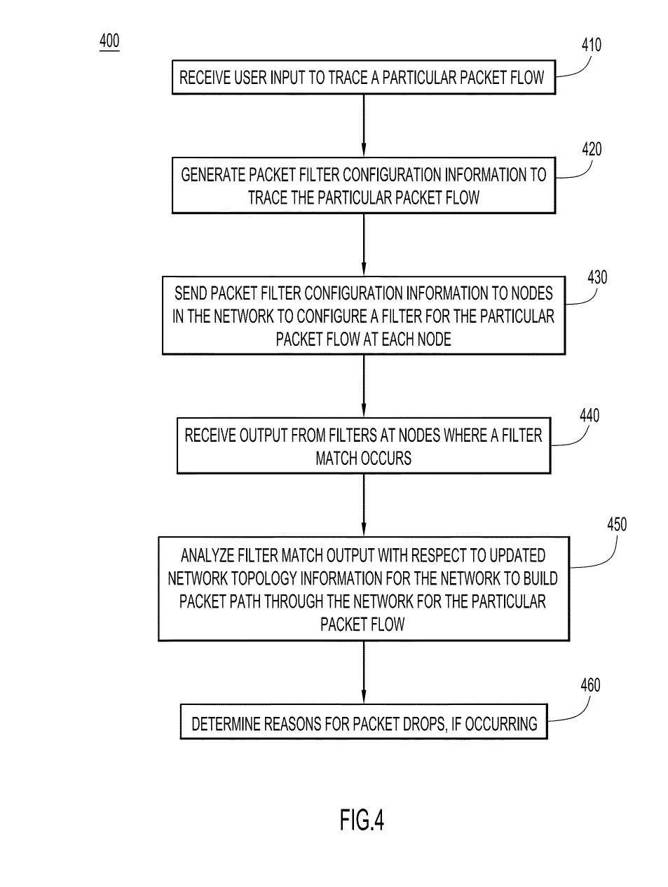

Turning now to FIG. 4, a flow chart is shown for a process 400 according to the embodiments presented herein. At 410, a user (e.g., a network administrator) supplies, via a user terminal, input data describing a particular packet flow to be traced. This data is received as input at the network controller. At 420, the network controller generates packet filter configuration information (using any of the packet field parameters described above) to trace the particular packet flow through the data center fabric network. The network controller may supply the filter configuration information to all nodes in the network. At 430, the network controller sends the packet filter configuration information to nodes in the network to configure a filter for the particular packet flow at each node. For example, ACI uses Extensible Markup Language (XML) or JavaScript Object Notation (JSON) type form to communicate between the network controller and the nodes. The filter output is sent as XML or JSON. At this point, the filters at the nodes begin operating to detect a match against packets that pass through the respective nodes. When a match occurs at a node, the node sends log data to the network controller, as described above.

At 440, the network controller receives the log data from the filters at nodes where a match occurs. At 450, the network controller analyzes the filter match output with respect to network topology information for the network in order to build a packet path through the network for the packet flow. At 460, the network controller may determine reasons for packet drops, if such drops are determined to occur in the path of a packet flow.

To summarize, presented herein are techniques for a tool that takes a list of nodes (e.g., switches) and packet flow parameters for a particular packet flow in order to trace and produce the packet path for the flow. ELAM packet filters in the network processor ASICs may be used to filter the packet and log the forwarding information, which is sent back to the network controller. In data center fabrics using dynamic load balancing schemes, these techniques give an accurate packet path of a specific packet flow at a given time. This also avoids the need to inject a debug packet like in existing tools. The tool also provides a method to collect forwarding data from all the nodes in the network to quickly debug where and why a packet flow is getting dropped in the network.

Thus, these techniques can determine where a packet flow is getting dropped in the case the receiving node does not receive the packets. The last node where the packets hit the filter is the ‘culprit’ node in the path. If the network processor ASIC of that node is capable of giving the drop reason, then the drop reason can be captured by the filter output, which can help in quick triaging of the problem.

There are many advantages to these techniques. In particular, in dynamic load balancing schemes, the same packet flow can take different paths at different times based on its bandwidth. A traditional traceroute utility cannot inject a packet in the same packet flow, and therefore it cannot help in debugging a specific packet flow if it gets dropped. There are no known utilities that can gather forwarding data from all the nodes where the packet flow was seen, in order to be able to debug any packet flow drops in a fabric network. The techniques presented herein can trace a packet path without needing to send additional debug packets.

In summary, in one form, a method is provided comprising: at a network controller that is communication with a plurality of nodes in a network: generating filter configuration information to track a particular packet flow, the filter configuration information including one or more parameters of the particular packet flow; sending the filter configuration information to the plurality of nodes in order to configure a filter for the particular packet flow at each of the plurality of nodes; receiving from one or more of the plurality of nodes where a filter match occurs output indicating that a packet matching the filter configuration information for the filter for the particular packet flow passed through the associated node; and analyzing the output received from one or more of the plurality of nodes where a filter match occurs to determine a path through the network for the particular packet flow.

In another form, a system is provided comprising: a plurality of nodes in a network, each node including a plurality of ports and one or more network processors that are used to process packets that are received at one of the plurality of ports for routing in the network; a network controller in communication with the plurality of nodes, wherein the network controller is configured to: generate filter configuration information to track a particular packet flow, the filter configuration information including one or more parameters of the particular packet flow; send the filter configuration information to the plurality of nodes in order to configure a filter for the particular packet flow at each of the plurality of nodes; receive from one or more of the plurality of nodes where a filter match occurs output indicating that a packet matching the filter configuration information for the filter for the particular packet flow passed through the associated node; and analyze the output received from one or more of the plurality of nodes where a filter match occurs to determine a path through the network for the particular packet flow.

In still another form, an apparatus is provided comprising: a network interface unit configured to enable communications over a network; a memory; a processor coupled to the network interface unit and the memory, wherein the processor is configured to: generate filter configuration information to track a particular packet flow through a network that includes a plurality of nodes, the filter configuration information including one or more parameters of the particular packet flow; send, via the network interface unit, the filter configuration information to the plurality of nodes in order to configure a filter for the particular packet flow at each of the plurality of nodes; receive, via the network interface unit, from one or more of the plurality of nodes where a filter match occurs output indicating that a packet matching the filter configuration information for the filter for the particular packet flow passed through the associated node; and analyze the output received from one or more of the plurality of nodes where a filter match occurs to determine a path through the network for the particular packet flow.

In yet another form, one or more non-transitory computer readable storage media are provided storing/encoded with instructions that, when executed by a processor, cause the processor to: generate filter configuration information to track a particular packet flow through a network that includes a plurality of nodes, the filter configuration information including one or more parameters of the particular packet flow; cause the filter configuration information to be sent to the plurality of nodes in order to configure a filter for the particular packet flow at each of the plurality of nodes; receive, via the network interface unit, from one or more of the plurality of nodes where a filter match occurs output indicating that a packet matching the filter configuration information for the filter for the particular packet flow passed through the associated node; and analyze the output received from one or more of the plurality of nodes where a filter match occurs to determine a path through the network for the particular packet flow.

The above description is intended by way of example only.

What is claimed is:

1. A method comprising:
at a network controller that is communication with a plurality of nodes in a network:
generating filter configuration information to track a particular packet flow, the filter configuration information including one or more parameters of the particular packet flow;
sending the filter configuration information to the plurality of nodes in order to configure a filter for the particular packet flow at each of the plurality of nodes;
receiving from one or more of the plurality of nodes where a filter match occurs output indicating that a packet matching the filter configuration information for the filter for the particular packet flow passed through the associated node; and
analyzing the output received from one or more of the plurality of nodes where a filter match occurs to determine a path through the network for the particular packet flow.

2. The method of claim 1, further comprising determining a node at which a packet is dropped and a cause of a packet drop for the particular packet flow based on the analyzing.

3. The method of claim 1, wherein the output received from the filter at a node where a filter match occurred includes information identifying an incoming interface of the packet at the node where the filter match occurred.

4. The method of claim 3, wherein the output received from the filter at a node where a filter match occurred includes information indicating whether the packet matching the filter was forwarded or dropped by the node, and any associated next hop details of the packet at the node where the packet match occurred.

5. The method of claim 1, wherein the filter configuration information is based on any one or more fields of a packet.

6. The method of claim 1, wherein analyzing is performed with respect to network topology information for the network.

7. The method of claim 6, further comprising receiving from the plurality of nodes information indicating changes in network topology of the network, and wherein analyzing is based on updated network topology information received from the plurality of nodes.

8. The method of claim 1, wherein generating comprises generating filter configuration information for each of a plurality of filters for a corresponding one of a plurality of packet flows to be tracked through the network, sending comprises sending filter configuration for each of the plurality of packet flows, receiving comprises receiving output indicating packets matching any of the plurality of filters passed through associated nodes in the network, and analyzing comprises analyzing the output to determine a path for one or more of the plurality of packet flows through the network.

9. The method of claim 1, further comprising receiving user input to trace the particular packet flow, and wherein generating is performed based on the user input.

10. A system comprising:
a plurality of nodes in a network, each node including a plurality of ports and one or more network processors that are used to process packets that are received at one of the plurality of ports for routing in the network;
a network controller in communication with the plurality of nodes, wherein the network controller is configured to:
generate filter configuration information to track a particular packet flow, the filter configuration information including one or more parameters of the particular packet flow;
send the filter configuration information to the plurality of nodes in order to configure a filter for the particular packet flow at each of the plurality of nodes;
receive from one or more of the plurality of nodes where a filter match occurs output indicating that a packet matching the filter configuration information for the filter for the particular packet flow passed through the associated node; and
analyze the output received from one or more of the plurality of nodes where a filter match occurs to determine a path through the network for the particular packet flow.

11. The system of claim 10, wherein the one or more network processors on each node implements the filter for the associated node.

12. The system of claim 11, wherein the filter is implemented with embedded logic analyzer module technology.

13. The system of claim 10, wherein the network controller further determines a node at which a packet is dropped and a cause of a packet drop for the particular packet flow.

14. The system of claim 10, wherein the output received from the filter at a node where a filter match occurred includes information identifying an incoming interface of the packet at the node where the filter match occurred.

15. The system of claim 14, wherein the output received from the filter at a node where a filter match occurred includes information indicating whether the packet matching the filter was forwarded or dropped by the node, and any associated next hop details of the packet at the node where the packet match occurred.

16. The system of claim 10, wherein the network controller generates filter configuration information for each of a plurality of filters for a corresponding one of a plurality of packet flows to be tracked through the network, sends filter configuration for each of the plurality of packet flows to the plurality of nodes, receives output indicating packets matching any of the plurality of filters passed through associated nodes in the network, and analyzes the output to determine a path for one or more of the plurality of packet flows through the network.

17. An apparatus comprising:
a network interface unit configured to enable communications over a network;
a memory;
a processor coupled to the network interface unit and the memory, wherein the processor is configured to:
generate filter configuration information to track a particular packet flow through a network that includes a plurality of nodes, the filter configuration information including one or more parameters of the particular packet flow;
send, via the network interface unit, the filter configuration information to the plurality of nodes in order to configure a filter for the particular packet flow at each of the plurality of nodes;
receive, via the network interface unit, from one or more of the plurality of nodes where a filter match occurs output indicating that a packet matching the filter configuration information for the filter for the particular packet flow passed through the associated node; and
analyze the output received from one or more of the plurality of nodes where a filter match occurs to determine a path through the network for the particular packet flow.

18. The apparatus of claim 17, wherein the processor further determines a node at which a packet is dropped and a cause of a packet drop for the particular packet flow.

19. The apparatus of claim 17, wherein the output received from the filter at a node where a filter match occurred includes information identifying an incoming interface of the packet at the node where the filter match occurred.

20. The apparatus of claim 19, wherein the output received from the filter at a node where a filter match occurred includes information indicating whether the packet matching the filter was forwarded or dropped by the node, and any associated next hop details of the packet at the node where the packet match occurred.

21. The apparatus of claim 17, wherein the processor is configured to generate filter configuration information for each of a plurality of filters for a corresponding one of a plurality of packet flows to be tracked through the network, send filter configuration for each of the plurality of packet flows to the plurality of nodes, receive output indicating packets matching any of the plurality of filters passed through associated nodes in the network, and analyze the output to determine a path for one or more of the plurality of packet flows through the network.
